(19) United States
(12) Patent Application Publication
(10) Pub. No.: US 2017/0348932 A1
(43) Pub. Date: Dec. 7, 2017

(54) METHOD FOR ASSEMBLING A TIRE BLANK

(71) Applicants: COMPAGNIE GENERALE DES ETABLISSEMENTS MICHELIN, CLERMONT-FERRAND (FR); MICHELIN RECHERCHE ET TECHNIQUE S.A., Granges-Paccot (CH)

(72) Inventors: FRÉDÉRIC PIALOT, Clermont-Ferrand (FR); GÉRARD BOR, Clermont-Ferrand (FR); YVES POTIN, Clermont-Ferrand (FR); THOMAS FABRE, Clermont-Ferrand (FR); MATTHIEU LUTZ, Clermont-Ferrand (FR)

(21) Appl. No.: 15/537,490

(22) PCT Filed: Dec. 22, 2015
(86) PCT No.: PCT/EP2015/081072

§ 371 Date: Jun. 19, 2017

(30) Foreign Application Priority Data
Dec. 23, 2014 (FR) 1463178

(51) Int. Cl. B29D 30/18; B29D 30/58; B29D 30/48; B60C 15/00; B29D 30/12

(52) U.S. Cl. CPC B29D 30/18; B60C 15/0018; B29D 30/12; B29D 30/48; B29D 30/58

(57) ABSTRACT

A method of manufacturing a tire includes steps of: providing a shoulder drum that includes shoulders having a height of at least equal to 25 mm; placing a carcass ply of a green tire on the shoulder drum; providing a winding of circumferential bead reinforcers around each end of the carcass ply, each winding having a number of turns providing a winding of circumferential bead reinforcers against each shoulder of the shoulder drum, each winding being in a spiral; and forming the green tire such that each end of the carcass ply does not have a turnup around the circumferential bead reinforcers, and the circumferential bead reinforcers are positioned in the green tire in a defined layout.

The invention relates to the field of manufacture of tires for passenger or utility vehicles and is more particularly concerned with the methods of building green tire blanks and more particularly still of assembling the constituent parts of the lower sidewall of the tires.

The lower sidewall of the tire is the name given to the part of the tire that extends from the region of contact with the rim of the wheel as far as the sidewalls of the tire.

The lower sidewall essentially has the role of connecting the carcass of the tire to the rim so as to transmit load while at the same time ensuring the airtightness of the contact region. The lower sidewall in particular comprises a circumferential reinforcement which binds the tire onto the rim seat.

This circumferential reinforcement usually takes the form of an annular collection of metal wires grouped together in the form of bundles of rectangular cross section or twisted in the form of cords. This type of circumferential reinforcement is generally known by the name of “bead wire”.

During tire manufacture, a green tire is first of all built which combines all the constituent elements of the future tire. The rubber-based products which represent a high proportion of the green tire have not yet been vulcanized at this stage. Once the green tire has been built, it is placed in a mould within a vulcanizing press in which the temperature and pressure applied to the green tire both mould the final shape of the tire and vulcanize the rubber.

Building the green tire is a complex process the precision of which is a decisive factor in the quality and performance of the finished tire. This is particularly true where the building of the part of the green tire intended to constitute the lower sidewall of the tire is concerned.

In order to fix the generally radial carcass reinforcers in the lower sidewall, these are conventionally turned up around the bead wire when building the green tire on a substantially cylindrical rotary drum. This part of the conventional method is referred to as “flat laying”. The green tire is then shaped, which means to say inflated to adopt its toroidal shape and accept the crown reinforcers and the tread of the tire. The complete green tire (the term “casing” is also used to denote the complete green tire) can then be placed in the vulcanizing mould. One difficulty with this type of method is dimensional control of the finished tire because the carcass has a tendency to shift while the green tire is being shaped, and this is accompanied by a rotation of the bead wire. Furthermore, during use of the tire, the cyclic variations in the tension of the carcass reinforcers also cause rotational movements of the bead wire and therefore significant deformations of the rubber in the lower sidewall. Because of the hysteresis of rubber, these elastic deformations of the lower sidewall generate energy losses that are not insignificant in the rolling resistance balance sheet for the tire.

Methods in which use is made of what is known as a shoulder drum are also known. This type of tire building drum comprises shoulders against which the bead wires are placed and which have the effect of building the bead region in a configuration similar to that of the finished tire. Rotation of the bead wire during shaping is then practically eliminated although the energy losses during use of the tire remain great.

According to another method of tire manufacture, it has also been proposed that all the constituent parts of the green tire be built on a substantially toroidal form corresponding to the interior form of the finished tire before the said form with the complete green tire is placed in the vulcanizing mould. In this type of manufacturing method, it has been proposed that the circumferential reinforcement be produced by winding several turns of a filamentary reinforcer on each side of the carcass reinforcers. One difficulty with this type of method is its complexity and therefore its industrial cost.

It is therefore an objective of the invention to alleviate at least one of the drawbacks described hereinabove.

For that reason, the invention proposes a method of manufacturing a tire comprising a step involving building a green tire blank on a shoulder drum, the said green tire comprising at least one carcass ply and circumferential bead reinforcers, the said method being characterized in that:
the shoulder drum comprises shoulders having a height at least equal to 25 mm,
the circumferential bead reinforcers are reinforcers wound over a number of turns around the green tire,
the circumferential bead reinforcers are placed in a spiral against the shoulder of the drum, the circumferential bead reinforcers being positioned in the said green tire in a substantially definitive layout,
the carcass ply does not have a turnup around the circumferential bead reinforcers.

For preference, the height of the shoulder of the drum is at least equal to 50 mm.

For preference, the axial faces of the shoulders of the shoulder drum form with the axis of the drum an angle smaller than 90°.

For preference, the axial faces of the shoulders of the shoulder drum form with the axis of the drum an angle comprised between 60 and 80°.

For preference, the winding of the circumferential bead reinforcers is prepared in the form of annular semi-finished products each comprising at least some of the said reinforcers wound in a spiral and a ring made from unvulcanized rubber.

For preference also, in succession:
a first annular semi-finished product is placed against each of the shoulders of the drum,
the carcass ply is placed so that it at least partially covers the first annular semi-finished product, and
a second annular semi-finished product is placed against each of the ends of the carcass ply.

According to an alternative form, the winding of the circumferential bead reinforcers is performed in situ by combining the rotation of the drum with the laying of the said reinforcers against the shoulder of the drum.

For preference also, a strip of unvulcanized rubber intended to constitute the filler in the lower sidewall is also wound.

For preference, a plurality of windings of circumferential bead reinforcers are superposed in the lower sidewall.

For preference, the method further comprises a subsequent step consisting in shaping the carcass of the green tire and in combining the green tire with the crown unit of the tire while keeping the said green tire on the said shoulder drum.

The invention also relates to a tire obtained by a method as described hereinabove.

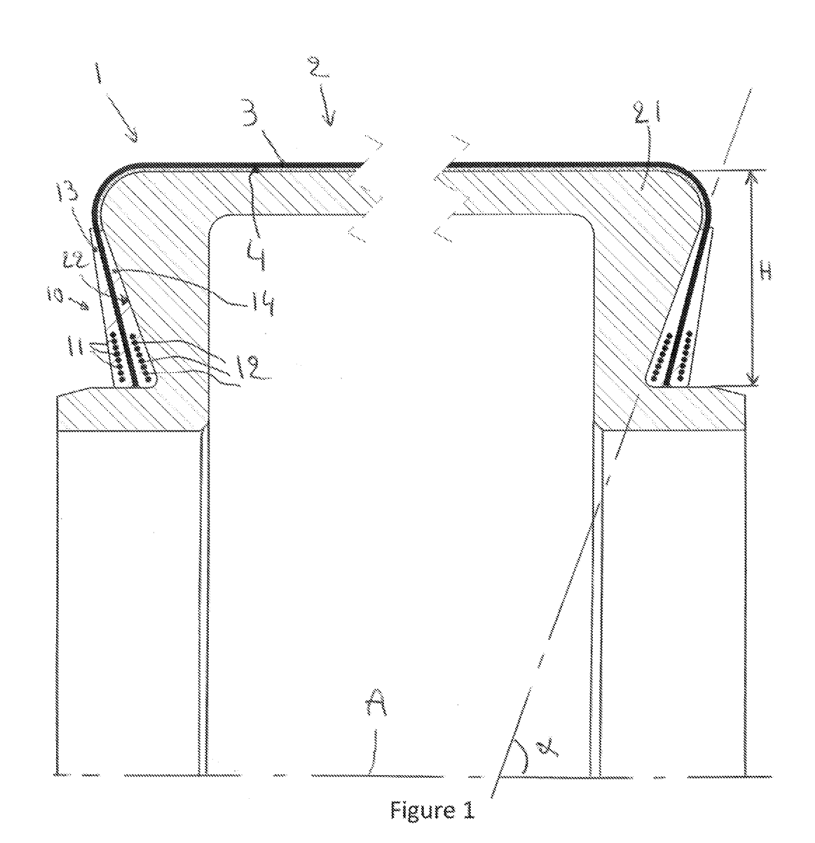

The following description provides a better understanding of the method according to the invention according to preferred embodiments of the invention and relies on FIGS. 1 to 7 in which:

FIG. 1 is a schematic view showing in cross section one essential principle of the method according to the invention,

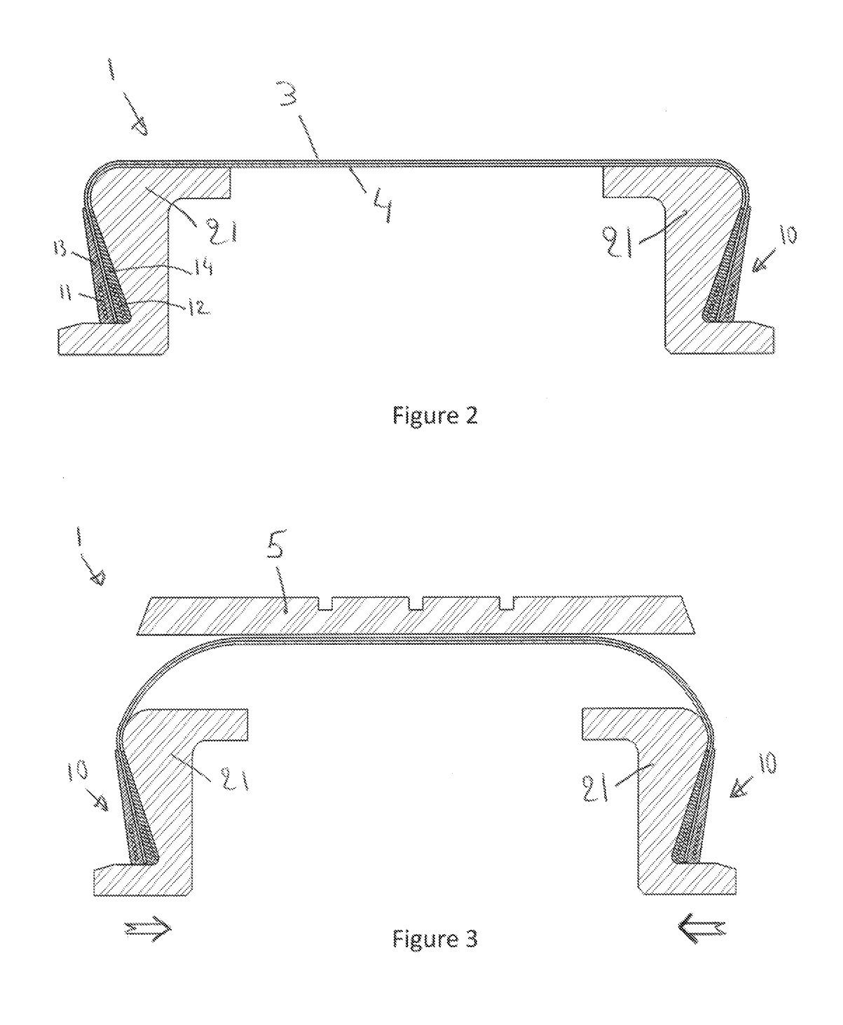

FIGS. 2 to 4 show a succession of steps of a first embodiment of the method of the invention,

FIG. 5 shows in cross section a green tire obtained during the course of the method of FIGS. 2 to 4,

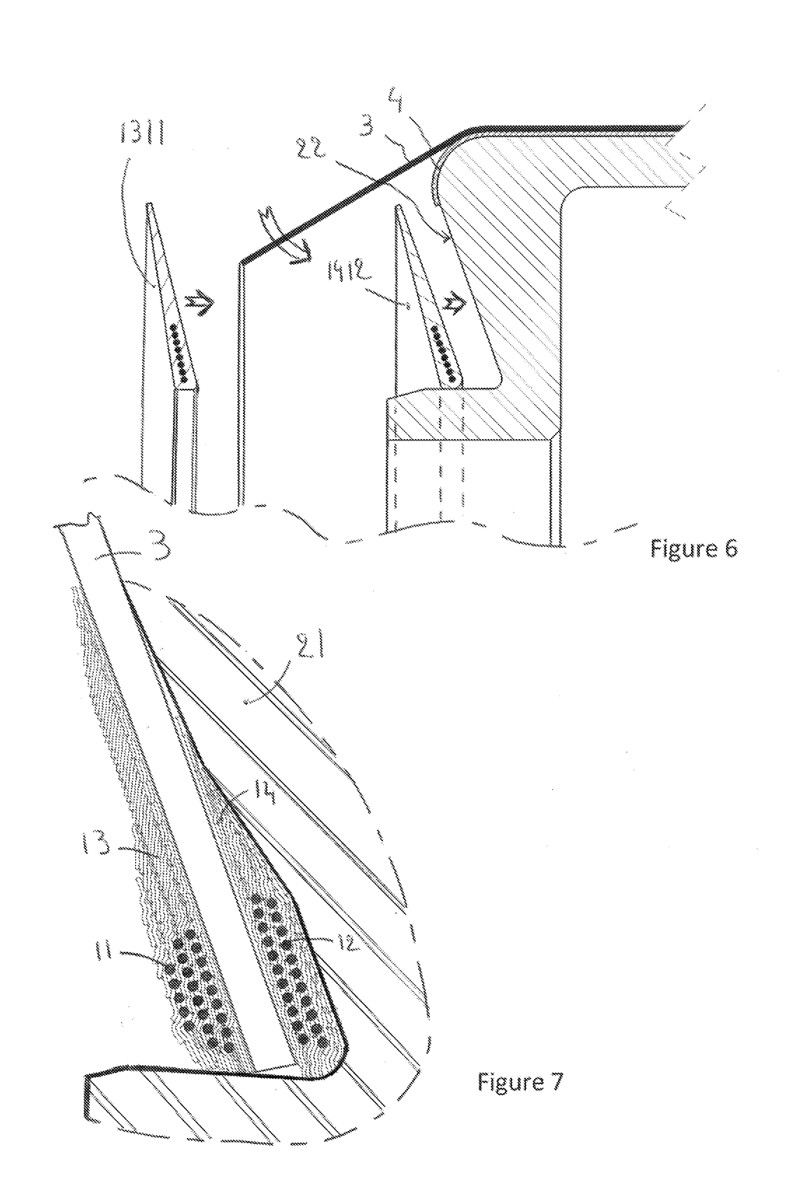

FIG. 6 schematically depicts details of a preferred embodiment of the method of the invention,

FIG. 7 illustrates an alternative form of the embodiment of FIG. 6.

In the various figures, elements which are identical or similar bear the same references. The description of the structure and function of these identical or similar elements is therefore not systematically repeated.

FIG. 1 shows the essential principles of the method according to the invention. The relevant parts of a shoulder drum 2 have been depicted schematically in cross section. The central part of the drum is interrupted in order to make the drawing clearer. Each of the shoulders 21 of the drum and the particular features of the building, according to the method of the invention, of the lower sidewalls 10 of the green tire 1 can thus be seen on a larger scale.

The drum 2 comprises an axis of rotation A. Each shoulder 21 of the shoulder drum comprises an axial face 22 making an angle α with the axis A of the drum. The angle α is preferably less than 90° and more preferably still comprised between 60 and 80°.

The shoulders have a height H. This height H is greater than 25 mm according to the invention and preferably greater than 50 mm in particular for assembling tires for utility vehicles (“heavy goods vehicles”), namely tires intended to bear heavy loads under a pressure of at least 5 bar with a load index in excess of 120.

The key constituent parts of the green tire 1 at this stage of tire building and, in particular, those of the lower sidewalls 10 are clearly visible in FIG. 1. The carcass ply 3 covers the entire drum, from one lower sidewall to the other. An inner liner 4 is visible on the inside of the carcass ply. In each lower sidewall, the carcass ply is positioned between two bundles of circumferential bead reinforcers. Outer reinforcers 11 can be distinguished here from inner reinforcers 12. Each of the said bundles of circumferential reinforcers is made up of a spiral winding of several turns of a filamentary reinforcer which turns are laid against the axial face 22 of the shoulder of the drum, namely parallel thereto. Viewed in cross section, each bundle may, as here, take the form of a single layer or of several layers. Rubber profiled elements 13 and 14 protect both the circumferential reinforcers and the carcass ply, by preventing any direct contact between them and with the external environment of the lower sidewall. This is also referred to as the “lower sidewall filler”.

The carcass ply 3 therefore has no turnup around the circumferential bead reinforcers. It is simply held between the two bundles of reinforcers. At this stage in the method, the lower sidewall is complete and it will be appreciated that the circumferential bead reinforcers and also the volumes of rubber are already in position in the green tire in their substantially definitive layout, namely substantially in the layout they will have in the finished tire after it has been moulded. Such a lower sidewall therefore experiences no significant deformation or rotation, either during shaping or during use of the finished tire.

After the method step depicted in FIG. 1, the drum can be extracted from the green tire. The green tire can then be picked up on another support before being shaped (namely before being inflated to adopt its toroidal shape) and before receiving the crown reinforcers and the tread.

FIGS. 2 to 4 depict a preferred embodiment of the method of the invention in which the later steps of the tire building are performed on the same drum 2 as was used for the steps depicted in FIG. 1. For the sake of simplicity, the central part of the drum has not been depicted.

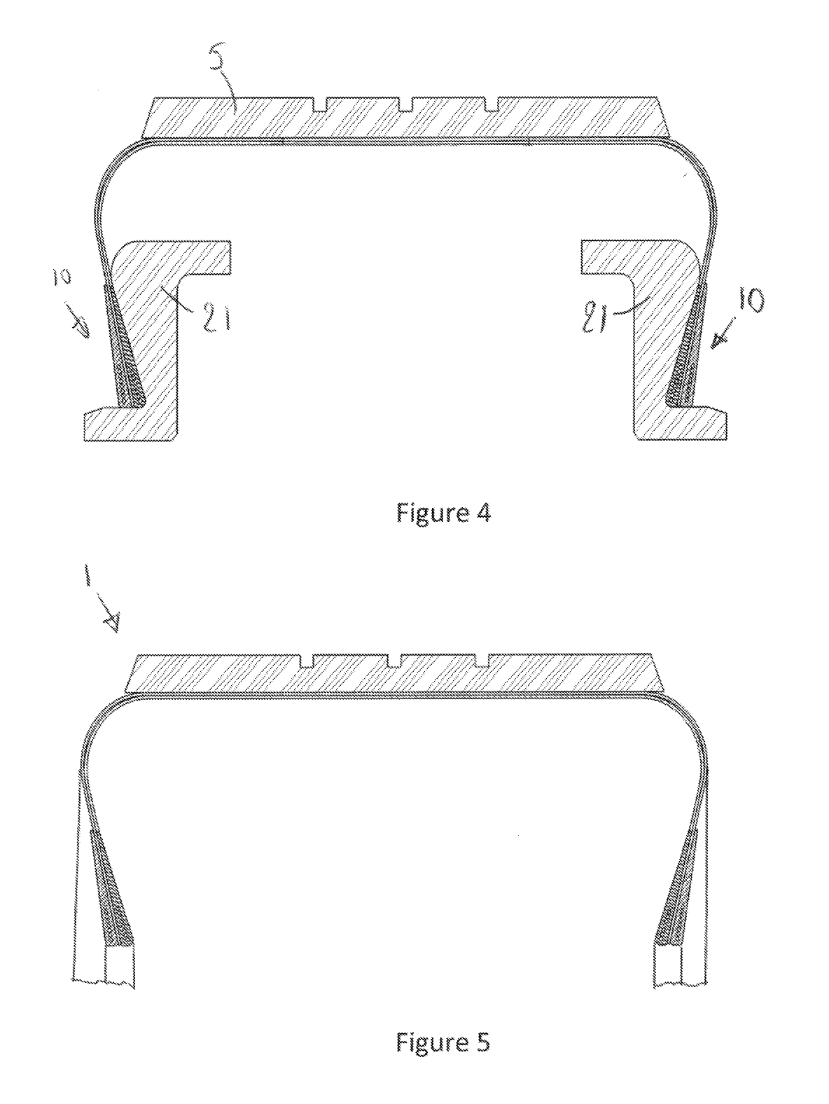

FIG. 2 therefore shows the green tire blank 1 in the state of FIG. 1, namely with the carcass and lower sidewalls assembled on the shoulder drum 2. In FIG. 3, the green tire remains connected to the drum by its lower sidewalls 10 while the length of the drum is gradually reduced (the shoulders of the drum move closer to one another) while an internal pressure forces the carcass to adopt a toroidal shape and then to press itself firmly against the inside of a crown ring 5. The crown ring may combine all the crown reinforcers and the tread in a way known per se in the field of tire building. FIG. 4 corresponds to the moment at which the green tire is completely assembled and shaped, ready to be separated from the drum and then placed in the vulcanizing mould.

As FIGS. 3 and 4 show, and so as to allow the green tire built on the shoulder drum 2 to be shaped when the shoulders 21 move closer together, the shoulders 21 of the shoulder drum 2 have a height H that is less than the height of the sidewalls of the shaped green tire. According to the invention, and whatever the type of tire being built, the shoulders 21 of the shoulder drum 2 have a height H smaller than the height of the sidewalls of the future tire.

FIG. 5 shows the complete green tire separated from the drum and ready to be moulded.

FIG. 6 illustrates a preferred embodiment of the method of the invention, in which embodiment the circumferential bead reinforcers are prepared in the form of annular semi-finished products comprising the said reinforcers wound in a spiral associated with an unvulcanized rubber ring intended to fill the lower sidewall. These subassemblies 1311 and 1412 are thus easy to handle a little like the bead wires in the conventional method. In order to obtain the lower sidewall architecture described in the preceding figures, the method here consists in placing a first semi-finished ring 1412 against the axial face 22 of each shoulder of the drum, and then in folding the ends of the carcass ply 3 over this inner ring before placing a second semi-finished ring 1311 over each of the ends of the carcass ply 3. It will be appreciated that other designs of tire can be obtained according to the invention by varying the number and type of semi-finished rings placed on each side of the carcass. The carcass reinforcement may also be made up of two or more superposed plies between which such annular semi-finished products may also be interposed in the lower sidewall.

Another way of forming the spiral-winding of the filamentary reinforcer may be to lay a bare filament and a strip of rubber according to the method described in the patent application published under number WO2006/067069. In that case, the rubber profiled elements 13 and 14 are preferably produced by a great many turns of the strip of rubber. FIG. 7 illustrates this alternative form. The circumferential reinforcers 11 and 12 comprise several turns of filament wound in situ during the rotation of the drum and associated over several layers with a strip of rubber wound according to the same principle, at the same time or not as described in document WO2006/067069. It will be appreciated that, in a similar way to FIG. 6, the interior part (12, 14) of the lower sidewall is produced against the drum, and then the carcass ply 3 is folded over this first subassembly before the exterior part (11, 13) is produced on top of the carcass. This figure also illustrates the case of a plurality of layers of reinforcers as mentioned hereinabove.

The method of the invention makes it possible to manufacture, in a way which is simple and therefore industrially robust, tires the lower sidewall of which is lightweight, strong and plays only a very small part in the rolling resistance of the tire.

Within the context of the invention, any suitable type of filamentary reinforcer can be used for the circumferential windings, for example a monofilament or a metal cord, a textile thread (such as an aramid or hybrid cord) or an inorganic thread (glass fibre).

1-11. (canceled)

12: A method of manufacturing a tire, the method comprising steps of:
providing a shoulder drum that includes shoulders each having a height equal to at least 25 mm;
placing a carcass ply of a green tire on the shoulder drum;
providing
an inner winding of circumferential bead reinforcers against each of the shoulders of the shoulder drum, each inner winding being in a spiral, and
an outer winding of circumferential bead reinforcers around each end of the carcass ply, each outer winding having a number of turns,
wherein the inner and outer windings are provided such that the circumferential bead reinforcers are positioned in the green tire in a defined layout; and
forming the green tire such that each end of the carcass ply does not have a turnup around the circumferential bead reinforcers.

13: The method according to claim 12, wherein the height of the shoulders of the shoulder drum is equal to at least 50 mm.

14: The method according to claim 12, wherein axial faces of the shoulders of the shoulder drum form an angle (α) of less than 90° with an axis of the shoulder drum.

15: The method according to claim 14, wherein the angle (α) is between 60 and 80°.

16: The method according to claim 12,
wherein the inner and outer windings are provided as annular semi-finished products, and
wherein, for each of the inner and outer windings, a ring made from unvulcanized rubber is included and the circumferential bead reinforcers are wound in a spiral.

17: The method according to claim 12, wherein the step of providing the inner and outer windings includes, in succession:
placing a first annular semi-finished product against each of the shoulders of the shoulder drum,
positioning the carcass ply so that the carcass ply at least partially covers the first annular semi-finished products, and
placing a second annular semi-finished product against each end of the carcass ply.

18: The method according to claim 12, wherein, in the step of providing the inner and outer windings, the inner windings are provided by rotating the shoulder drum while laying the circumferential bead reinforcers against the shoulders of the shoulder drum.

19: The method according to claim 18, further comprising a step of winding a strip of unvulcanized rubber on the shoulder drum to form a filler in a lower sidewall of the green tire.

20: The method according to claim 12, wherein, in the step of providing the inner and outer windings, a plurality of windings of circumferential bead reinforcers are superposed in a region forming a lower sidewall of the green tire.

21: The method according to claim 12, further comprising steps of:
shaping a carcass of the green tire; and
combining the green tire with a crown unit without removing the green tire from the shoulder drum.

22: A tire comprising:
a carcass; and
circumferential bead reinforcers,
wherein the tire is manufactured by a method that includes:
providing a shoulder drum that includes shoulders each having a height equal to at least 25 mm,
placing a carcass ply of a green tire on the shoulder drum,
providing
an inner winding of circumferential bead reinforcers against each of the shoulders of the shoulder drum, each inner winding being in a spiral, and
an outer winding of circumferential bead reinforcers around each end of the carcass ply, each outer winding having a number of turns,
wherein the inner and outer windings are provided such that the circumferential bead reinforcers are positioned in the green tire in a defined layout, and
forming the green tire such that each end of the carcass ply does not have a turnup around the circumferential bead reinforcers.
